(19) United States
(12) Patent Application Publication
(10) Pub. No.: US 2026/0284611 A1
(43) Pub. Date: Sep. 24, 2026

(54) A MIXING DEVICE AND A METHOD FOR MIXING A FIRST SUBSTANCE AND A SECOND SUBSTANCE TO FORM A MIXED SUBSTANCE

(71) Applicant: MAGNETS FOR EMULSIONS N.V., OOSTKAMP (BE)

(72) Inventors: Nielsen WILLEMARCK, OOSTKAMP (BE); Johan Adriaan MARTENS, OOSTKAMP (BE)

(73) Assignee: MAGNETS FOR EMULSIONS N.V., OOSTKAMP (BE)

(21) Appl. No.: 19/475,178

(22) PCT Filed: Apr. 15, 2024
(86) PCT No.: PCT/IB2024/053669

§ 371 Date: Oct. 14, 2025

(30) Foreign Application Priority Data
Apr. 14, 2023 (NL) 2034578

(51) Int. Cl. B01F 25/312; B01F 23/50

(52) U.S. Cl. CPC B01F 25/31242; B01F 23/56; B01F 25/312512; B01F 25/312522; B01F 2215/0431

(57) ABSTRACT

A mixing device having a venturi tube section comprising an inlet and an outlet having a channel arranged there between, wherein the channel comprises venturi tube section with a first feed opening in the side wall in a first direction, wherein the first feed opening is connected to the primary second inlet, and the first feed opening having a feed axis in the first direction which is substantially perpendicular to the flow axis of the flow channel; and a second feed opening in the side wall in a second direction, wherein the second feed opening is connected to the secondary second inlet, and the second feed opening having a feed axis in the second direction which is substantially perpendicular to the flow axis of the flow channel, wherein the second feed opening is arranged upstream from the first feed opening.

The invention relates to a mixing device for mixing a first substance and a second substance to form a mixed substance, wherein the first substance is a liquid and the second substance is a liquid or a powder.

Mixed substances such as dispersions or emulsions may be prepared for instance by using a device comprising a high shear mixer or by using a Venturi type mixer. Known mixing devices, for example the educator described in US2005/0189081, have the disadvantage that the solids are inserted in a cavernous mixing chamber being substantially larger than the initial venturi, thus creating a substantial pressure drop. This pressure drop greatly reduces the velocity of the first substance. US2005/0189081 suboptimally mixes the first substance with the second substance. Moreover, the plurality of diverging and converging sections generate a choked flow downstream of the mixing chamber further increasing back pressure and further reducing mixing efficiency.

According to an aspect of the invention a mixing device for mixing a first substance and a second substance to form a mixed substance, wherein the first substance is a liquid and the second substance is a liquid or a powder is provided. The mixing device comprises a housing having a first inlet for the first substance, a primary second inlet for the second substance, a secondary second inlet and an outlet for the mixed substance. A flow channel is arranged between the first inlet and the outlet, wherein the flow channel having a flow axis between the first inlet and the outlet, and wherein the flow channel comprises a side wall which is provided, seen in a flow direction, with a first constrictor section near the first inlet, an expander section near the outlet, and a venturi tube section, between the first constrictor section and the expander section; wherein the venturi tube section comprises a first feed opening in the side wall in a first direction, wherein the first feed opening is connected to the primary second inlet, and the first feed opening having a feed axis in the first direction which is substantially perpendicular to the flow axis of the flow channel and a second feed opening in the side wall in a second direction, wherein the second feed opening is connected to the secondary second inlet, and the second feed opening having a feed axis in the second direction which is substantially perpendicular to the flow axis of the flow channel, wherein the second feed opening is arranged upstream from the first feed opening. A mixing device having a primary second inlet and secondary second inlet allows to redirect the initially mixed flow, i.e. the substance coming from the first inlet being mixed with the substance from the primary second inlet, to the secondary second inlet and insert the initially mixed flow back into the venturi tube section. In this way, chunks, larger particles of or clumped material which would otherwise cause blockage at the inlet of the venturi tube section are allowed to pass such that the chunks, larger particles or clumped material can be further mixed into a more homogeneous mixed material. Moreover, once the mixed material is fine enough, it may be redirected back to the first inlet such that flow speeds can be increased to further improve the mixing of the substances. Due to the increase in velocity, fluid dynamic blockage can occur due to the substance reaching turbulent flow regimes. In this cans, the mixed substances can be redirected to the secondary second inlet, resolving the choke issue which would otherwise occur.

Preferably, the venturi tube section comprises a first constricted portion having a first cross section, a second constricted portion having a second cross section and a third constricted portion having a third cross section, wherein the first constricted portion is smaller than the second cross section and wherein the second cross section is smaller than the third cross section, and wherein the second feed opening is arranged in the second constricted portion and the first feed opening is arranged in the second constricted portion.

More preferably, the venturi tube section comprises a slit-like cross-section having a width which is substantially larger than a height. More preferably, the width of the first, second and third constricted portion is constant, seen in a flow direction, and the height of the first constricted portion is at least two times smaller than the height of the second constricted portion, and wherein the height of the second constricted portion is at least, smaller than the height of the third constricted portion. The use of a conventional Venturi with a tube section having a round cross section results in a ratio of the first feed opening surface vs. the constriction tube section surface area of (max) 1:1. As a result the quantity of the second substance that will be brought into the flow of the first substance will happen in approximately the same ratio. By using a slitted venturi rather than a usual tubular Venturi a stronger turbulent flow can be created, resulting in better and/or faster mixing. Furthermore, the circumference of a slit is relatively high compared to a round tube, which results in higher shear force acting on the substances to be mixed, thereby resulting in a better or faster mixing. Furthermore the ratio between the first feed opening surface vs. the constriction tube section surface can be increased substantially, also resulting in a better or faster mixing. The slitted Venturi also creates the possibility to choose between different surface areas for the first feed opening, for instance by applying a reducer in the opening, for achieving an optimized feed ratio for the applicable second substance, in view of the under pressure suction force of the Venturi.

Preferably, the transition between the first, second and third constricted portion is a step transition.

Preferably, the second feed opening is arranged at the proximal end of the second constricted portion.

Preferably, the length of the second constricted portion downstream of the second feed opening is approximately equal or larger than the length of the second feed opening seen in the direction of the flow axis.

Preferably, the surface area of the second feed opening is more than 1.25 times, preferably more than 2.5 times, more preferably more than 5 times the surface area of flow channel in the second constricted portion.

Preferably, a length of the first constrictor section, seen in the direction of the flow axis is between 1 mm and 10 mm.

Preferably, the width of the first constricted portion is between 1 mm and 10 mm, preferably between 1.5 mm and 4 mm.

Preferably, the housing is made of one integral part.

Preferably the width of the second feed opening in the second direction is approximately equal to (i.e. preferably at least 80% or 90% of) the second width of the first constricted portion. Preferably the width of the second feed opening in the second lateral direction is approximately equal to (i.e. preferably at least 80% or 90% of) the second width of the first constricted portion.

Preferably the width of the first feed opening in the second direction is approximately equal to (i.e. preferably at least 80% or 90% of) the second width of the first constricted portion. Preferably the width of the first feed opening in the second lateral direction is approximately equal to (i.e. preferably at least 80% or 90% of) the second width of the first constricted portion.

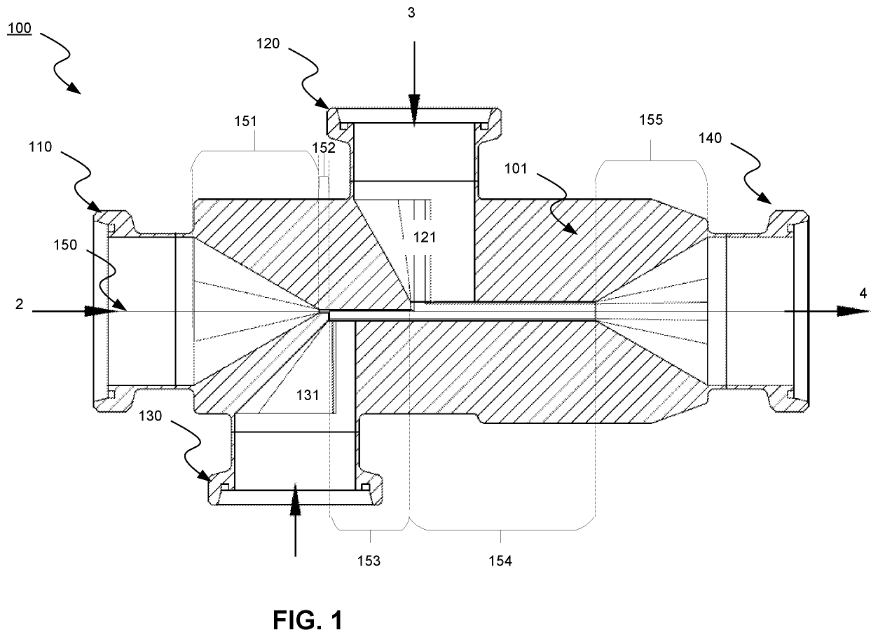

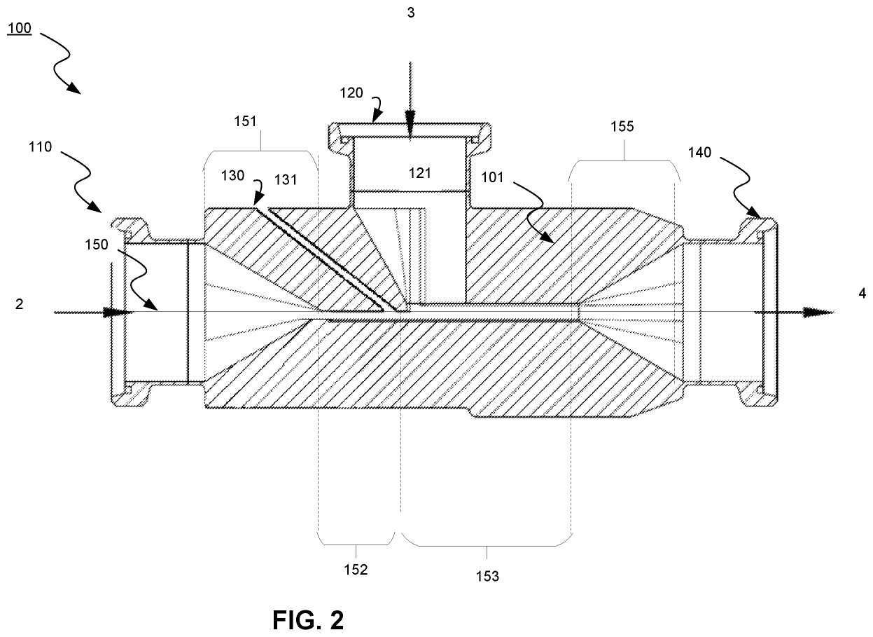

The invention will be elucidated by means of an exemplary preferred embodiment, with reference to the figures, wherein FIG. 1 shows a vertical cross section of an exemplary embodiment of the mixing device, and FIG. 2 shows a vertical cross section of an alternative exemplary embodiment of the mixing device.

In FIG. 1 a vertical cross section of a mixing device 100 for mixing a first substance 2 and a second substance 3 is shown. By mixing the first and second substance a mixed substance 4 is formed. The first substance 2 is a liquid and the second substance 3 is a liquid or a powder or particulate.

The mixing device 100 comprises a housing 101 having a first inlet 110 for the first substance 2. The first inlet 110 can comprise a flanged connection or may be welded.

The mixing device further comprises a primary second inlet 120 for the second substance and a secondary second inlet 130. In other words, the mixing device 100 comprises two further inlets which are, with respect to the first inlet 110 denominated as secondary inlets. The plurality of inlets can also be referred to as a first inlet 110, a second inlet 120 and a third inlet 130. Moreover, the mixing device comprises an outlet 140 for the mixed substance 4 to exit the mixing device 100.

The first substance 2 is typically stored in a storage tank, of which the bottom outlet is connected to the inlet by means of inlet pipe, in which a pump is arranged to pump the first substance 2 into the mixing device at high pressure.

The second substance 3 is typically stored in a hopper located vertically above the mixing device 100, of which the bottom outlet is connected to the primary second inlet 120 of the mixing device 1 by means of a pipe.

A flow channel 150 is arranged between the first inlet 110 and the outlet 140, the flow channel having a flow axis between the first inlet and the outlet. The flow channel 150 comprises a side wall which is provided, seen in a flow direction, with a first constrictor section 151 near the first inlet, an expander section 155 near the outlet, and a venturi tube section 152, 153, 154 between the first constrictor section and the expander section.

The venturi tube section comprises a first feed opening 121 in the side wall in a first direction. the first feed opening 121 is connected to the primary second inlet 120, is provided in the side wall of the constricted Venturi tube section, and has a feed axis which is substantially perpendicular to the flow axis 150 of the flow channel.

Further, a second feed opening 131 is provided in the side wall and is angled in a second direction. The second feed opening is connected to the secondary second inlet 130. The second feed opening has a feed axis in the second direction which is substantially perpendicular to the flow axis of the flow channel 150. The secondary second inlet 130 is connected, typically via a three way valve to the inlet pipe coming from the pump is. The three way valve allows to change the flow direction from the first inlet 120 to the secondary second inlet 130. A mixing device 100 having a primary second inlet 120 and secondary second inlet 130 allows to redirect the initially substance flow, i.e. the substance coming from the first inlet which is intended to being mixed with the substance from the primary second inlet 120, to the secondary second inlet 130 and insert the substance directly into the venturi tube section. The second feed opening is arranged upstream from the first feed opening. In this way, chunks, larger particles of or clumped material which would otherwise cause blockage at the inlet of the venturi tube section are allowed to pass such that the chunks, larger particles or clumped material can be further mixed into a more homogeneous mixed material. Also, once substances are mixed, it may be redirected back to the first inlet such that flow speeds can be increased to further improve the mixing of the substances. Due to the increase in velocity, fluid dynamic blockage can occur due to the substance reaching turbulent flow regimes. In this case, the mixed substances can be redirected to the secondary second inlet, resolving the choke issue which would otherwise occur.

The venturi tube section 152, 153, 154 comprises a first constricted portion 152 having a first cross section, a second constricted portion 153 having a second cross section and a third constricted portion 154 having a third cross section. The first constricted portion 152 is smaller than the second cross section and wherein the second cross section is smaller than the third cross section, and wherein the second feed opening is arranged in the second constricted portion and the first feed opening is arranged in the second constricted portion.

The venturi tube section 152, 153, 154 preferably comprises a slit-like cross-section having a width which is substantially larger than a height. The first constrictor section 151 near the first inlet 120 has pseudo-conical shape to accommodate the transition form the inlet 110 of the mixing device to the constricted Venture tube section 152. Similarly the tube section 140 between the cylindrical outlet 140 and the slit shaped outlet opening of the third constricted portion 154 has pseudo-conical shape to accommodate the transition form the constricted Venture tube section to the outlet 140 of the mixing device 100.

The outlet 140 of the mixing device 1 is connected to an inlet of the storage tank by means of a return pipe, such that the mixed substance may be recycled through the system until the required mixing grade is obtained. When recycling, the substance flow can be redirected to the secondary second inlet 130 to avoid blockage or to reduce choking in the venturi tube section.

In FIG. 2 a vertical cross section of a mixing device 100 for mixing a first substance 2 and a second substance 3 is shown. Mixing the first substance 2 and the second substance 3 forms a mixed substance. As mentioned hereabove, the first substance can be a liquid and the second substance can be a liquid or a powder. Similarly to the exemplary embodiment shown in FIG. 1, the mixing device 100 of FIG. 2 comprises a housing 101 having a first inlet 110 for the first substance 2. The first inlet 110 can comprise a flanged connection or may be welded.

The mixing device further comprises a primary second inlet 120 for the second substance and a secondary second inlet 130. In other words, the mixing device 100 comprises two further inlets which are, with respect to the first inlet 110 denominated as secondary inlets 120, 130. The plurality of inlets can also be referred to as a first inlet 110, a second inlet 120 and a third inlet 130. Moreover, the mixing device comprises an outlet 140 for the mixed substance 4 to exit the mixing device 100.

The first substance 2 is typically stored in a storage tank, of which an outlet can be connected to the inlet by means of inlet pipe, in which a pump is arranged to pump the first substance 2 into the mixing device at high pressure.

The second substance 3 is typically stored in a hopper located vertically above the mixing device 100, of which an outlet (not shown) is connected to the primary second inlet 120 of the mixing device 1 by means of a pipe.

A flow channel 150 is arranged between the first inlet 110 and the outlet 140, the flow channel having a flow axis between the first inlet and the outlet. The flow channel 150 comprises a side wall which is provided, seen in a flow direction, with a first constrictor section 151 near the first inlet, an expander section 155 near the outlet, and a venturi tube section 152, 153 between the first constrictor section and the expander section.

The venturi tube section comprises a first feed opening 121 in the side wall in a first direction. the first feed opening 121 is connected to the primary second inlet 120, is provided in the side wall of the constricted Venturi tube section, and has a feed axis which is substantially perpendicular to the flow axis 150 of the flow channel.

Further, a second feed opening 131 is provided in the side wall and is angled in a second direction. The second feed opening is connected to the secondary second inlet 130. The second feed opening has a feed axis in the second direction which is arranged acutely with respect to the flow axis of the flow channel 150. In other words, an acute, non-zero, angle can be seen between the feed axis of the second feed opening 131 and the flow axis of the flow channel 150. The feed axis of the second feed opening 131 is directed in a similar flow direction as the flow direction of the flow channel 150. In other words, the material flowing through the second feed opening is directed in substantially the same way as the material flowing through the flow channel 150. In this way the venturi effect in the flow channel 150 may be maintained or even increased. In other words, the angled entry, in the substantially same flow direction of the channel 150 does not throttle the material flow going through the channel 150, unlike the situation where the feed opening 131 is arranged with a straight angle with respect to the flow channel 150. Additionally, when a material flow comprising larger particles, for example pieces of onion in a sauce preparation, is input using the acutely angled second feed opening, the particles will maintain their structural integrity because the particles have less of a tendency to flow against the channel wall. The secondary second inlet 130 is connected, typically via a three way valve (not shown) to the inlet pipe coming from the pump is. The three way valve allows to change the flow direction from the first inlet 110 to the secondary second inlet 130. A mixing device 100 having a primary second inlet 120 and secondary second inlet 130 allows to redirect the initially substance flow, i.e. the substance coming from the first inlet which is intended to being mixed with the substance from the first inlet 110, to the secondary second inlet 130 and insert the substance directly into the venturi tube section. The second feed opening is arranged upstream from the first feed opening. Once substances are mixed, the substances may be redirected back to the first inlet such that flow speeds can be increased to further improve the mixing of the substances. Due to the increase in velocity, fluid dynamic blockage can occur due to the substance reaching turbulent flow regimes. In this case, the mixed substances can be redirected to the secondary second inlet, resolving the choke issue which would otherwise occur.

The venturi tube section 152, 153 comprises a first constricted portion 152 having a first cross section, a second constricted portion 153 having a second cross section. Unlike the mixing device 100 shown in FIG. 1, only two constricted portions 152 and 153 are present. The first and second constricted portions 152, 153 both have a constant cross sectional area, respectively. However, The first constricted portion 152 has a smaller cross sectional area than the second constricted portion 153.

The secondary second inlet 130 is connected via the second feed opening 131 to the flow channel 150 in the area of the first constricted portion 152, upstream of the second constricted portion 153 the second feed opening is arranged in the first constricted portion and the first feed opening is arranged in the second constricted portion. It has been found that the exemplary embodiment of the mixing device of FIG. 2 achieves similar results as the mixing device shown in FIG. 1, with the added benefit of being less prone to blockage and pitting.

Similarly to the exemplary embodiment of FIG. 1, the venturi tube section 152, 153 preferably comprises a slit-like cross-section having a width which is substantially larger than a height. The first constrictor section 151 near the first inlet 120 has pseudo-conical shape to accommodate the transition from the inlet 110 of the mixing device to the constricted Venture tube section 152. Similarly the tube section between the cylindrical outlet 140 and the slit shaped outlet opening of the second constricted portion 153 has pseudo-conical shape to accommodate the transition from the constricted Venture tube section to the outlet 140 of the mixing device 100.

The outlet 140 of the mixing device 1 is preferably connected to an inlet of the storage tank by means of a return pipe, such that the mixed substance may be recycled through the system until the required mixing grade is obtained.

The invention has thus been described by means of preferred embodiments. It is to be understood, however, that this disclosure is merely illustrative. Various details of the structure and function were presented, but changes made therein, to the full extent extended by the general meaning of the terms in which the appended claims are expressed, are understood to be within the principle of the present invention. The description and drawings shall be used to interpret the claims. The claims should not be interpreted as meaning that the extent of the protection sought is to be understood as that defined by the strict, literal meaning of the wording used in the claims, the description and drawings being employed only for the purpose of resolving an ambiguity found in the claims. For the purpose of determining the extent of protection sought by the claims, due account shall be taken of any element which is equivalent to an element specified therein. An element is to be considered equivalent to an element specified in the claims at least if the element performs substantially the same function in substantially the same way to yield substantially the same result as the element specified in the claims.

1. A mixing device for mixing a first substance and a second substance to form a mixed substance, wherein the first substance is a liquid and the second substance is a liquid or a powder;
wherein the mixing device comprises a housing having a first inlet for the first substance, a primary second inlet for the second substance, a secondary second inlet and an outlet for the mixed substance;
wherein a flow channel is arranged between the first inlet and the outlet, the flow channel having a flow axis between the first inlet and the outlet, and
wherein the flow channel comprises a side wall which is provided, seen in a flow direction, with a first constrictor section near the first inlet, an expander section near the outlet, and a venturi tube section between the first constrictor section and the expander section;
wherein the venturi tube section comprises
a first feed opening in the side wall in a first direction, wherein the first feed opening is connected to the primary second inlet, and the first feed opening having a feed axis in the first direction which is substantially perpendicular to the flow axis of the flow channel;
a second feed opening in the side wall in a second direction, wherein the second feed opening is connected to the secondary second inlet, and the second feed opening having a feed axis in the second direction which is substantially perpendicular to the flow axis of the flow channel, wherein the second feed opening is arranged upstream from the first feed opening, wherein the venturi tube section comprises a first constricted portion having a first cross section, a second constricted portion having a second cross section and a third constricted portion having a third cross section, wherein the first constricted portion is smaller than the second cross section and wherein the second cross section is smaller than the third cross section, and wherein the second feed opening is arranged in the second constricted portion and the first feed opening is arranged in the second constricted portion.

2. The mixing device according to claim 1, the venturi tube section comprises a slit-like cross-section having a width which is substantially larger than a height.

3. The mixing device according to claim 2, wherein the width of the first, second and third constricted portion is constant, seen in a flow direction, and wherein the height of the first constricted portion is at least two times smaller than the height of the second constricted portion, and wherein the height of the second constricted portion is at least 1.5 smaller than the height of the third constricted portion.

4. The mixing device according to claim 2, wherein the transition between the first, second and third constricted portion is a step transition.

5. The mixing device according to claim 2, wherein the second feed opening is arranged at the proximal end of the second constricted portion.

6. The mixing device according to claim 1, wherein the length of the second constricted portion downstream of the second feed opening is approximately equal or larger than the length of the second feed opening seen in the direction of the flow axis.

7. The mixing device according to claim 1, wherein the surface area of the second feed opening is more than 1.25 times, preferably more than 2.5 times, more preferably more than 5 times the surface area of flow channel in the second constricted portion.

8. The mixing device according to claim 1, wherein a length of the first constrictor section, seen in the direction of the flow axis is between 1 mm and 10 mm.

9. The mixing device according to claim 1, wherein the width of the first constricted portion is between 1 mm and 10 mm, preferably between 1.5 mm and 4 mm.

10. The mixing device according to claim 1, wherein the housing is made of one integral part.
